(19) United States
(12) Patent Application Publication
(10) Pub. No.: US 2024/0163789 A1
(43) Pub. Date: May 16, 2024

(54) METHOD FOR OPERATING A NODE IN A RADIO NETWORK AND NODE

(71) Applicant: Diehl Metering Systems GmbH, Nürnberg (DE)

(72) Inventors: Hristo Petkov, Nürnberg (DE); Thomas Kauppert, Nürnberg (DE)

(21) Appl. No.: 18/422,293

(22) Filed: Jan. 25, 2024

Related U.S. Application Data
(63) Continuation of application No. PCT/EP2022/073250, filed on Aug. 19, 2022.

(30) Foreign Application Priority Data
Sep. 3, 2021 (DE) 10 2021 122 872.7
Jan. 21, 2022 (DE) 10 2022 101 405.3

(51) Int. Cl. H04W 52/02

(52) U.S. Cl. CPC H04W 52/0216; H04W 52/0261

(57) ABSTRACT

A method operates a node in a radio network. The node has a transmitter and/or receiver for transmitting/receiving data packets. Each data packet is divided into a plurality of individual sub-data packets, and each sub-data packet is sent and/or received successively in a temporal transmission interval in the form of a radio burst. A plurality of pauses is provided, wherein the respective pause is provided between two adjacent radio bursts and is in each case longer than 7168 symbols based on a symbol rate of 2 380 371 Sym/s and/or radio bursts are combined into radio burst clusters. The radio bursts within the radio burst clusters are each sent and/or received successively in the temporal transmission interval, and the number of radio bursts in each radio burst cluster is lower than the number of radio bursts respectively predefined in accordance with ETSI TS 103 357 V1.1.1 (2018-06).

### CROSS-REFERENCE TO RELATED APPLICATION

This application is a continuation, under 35 U.S.C. § 120, of copending International Patent Application PCT/EP2022/073250, filed Aug. 19, 2022, which designated the United States; this application also claims the priority, under 35 U.S.C. § 119, of German Patent Application DE 10 2021 122 872.7, filed Sep. 3, 2021, and DE 10 2022 101 405.3, filed Jan. 21, 2022; the prior applications are herewith incorporated by reference in their entirety.

### FIELD AND BACKGROUND OF THE INVENTION

The present invention relates to a method for operating a node in a radio network in accordance with the preamble of the independent method claim. The present invention also relates to a node of a radio network in accordance with the preamble of the independent node claim.

The invention relates to a method for operating an energy-independently operated node in a radio network, preferably a radio network of the type described in ETSI TS 103 357 V1.1.1 (2018-06). This is a wireless network that uses license-free frequency bands. In such networks, a large number of nodes, in particular end nodes, are provided, which communicate with base stations via radio either only on the uplink or on the uplink and downlink. A node may be a sensor device for acquiring data of any kind, an actuator device for performing certain actions or measures, or a combination of a sensor device and an actuator device. Such nodes are operated with a dedicated, i.e. autonomous, power supply in the form of a non-rechargeable hard-wired long-life battery, which has a limited service life dependent on the individual energy consumption of the node and is not rechargeable, but must be replaced at the end of its service life. Under normal circumstances, such a battery can be used to achieve a service life of at least ten years “in the field” until replacement becomes necessary.

In order to buffer the energy from the battery, an energy buffer is used in the node, from which the power consumer (e.g. the receiver or transceiver of the node) obtains the required power. In bidirectional communication, for example, a telegram is first transmitted from the base station to the node on the downlink after a telegram of the node is transmitted on the uplink. The telegram or data packet is “split”, i.e. decomposed into individual sub-data packets, and these individual sub-data packets are then continuously received on the downlink or sent on the uplink as “radio bursts” or “radio bursts” with a temporal transmission interval T_RB(s). The radio bursts have a length of approximately 12 to 22 ms on the downlink and a length of approximately 15 ms on the uplink. According to ETSI TS 103 357 V1.1.1 (2018-06), the temporal transmission interval T_RB(s) of the adjacent radio bursts is approximately 230 ms on average on the downlink, and approximately 150 ms on average on the uplink. The sub-data packets can be sent in a single frequency channel, or alternatively, individually over different frequencies or frequency channels. In accordance with ETSI TS 103 357 V1.1.1 (2018-06), on the downlink it is proposed to combine radio bursts into blocks of an extension frame containing a plurality of radio bursts and to receive them with a pause ΔT_dn provided between the blocks. The standard also specifies a pause ΔT_Tsi between the core frame and the extension frame. The pauses ΔT_dn (block pause) and ΔT_Tsi (frame pause) can be up to 7,168 symbols or 65,532 symbols long. This corresponds to 3.011 s for ΔT do and 27.53 s for ΔT_Tsi.

### SUMMARY OF THE INVENTION

The object of the invention is to reduce their production costs of nodes while maintaining their performance.

### Achievement of the Object

The above object is achieved by the method according to the independent method claim and by the node according to the independent node claim. Advantageous embodiments of the method according to the invention are specified in the dependent claims.

It is provided according to the invention that at least two and preferably a plurality of pauses are provided, wherein the respective pause is provided between two adjacent radio bursts and is in each case longer than 7,168 symbols based on a symbol rate of 2,380,371 sym/s. The pause is a time window within which the transmission process of the radio bursts is interrupted or stopped. This means that the pause is not a pause between two frames (in particular the core frame and extension frame), which is defined as ΔT_si in the ETSI TS 103 357 V1.1.1 (2018-06), and nor is it the transmission interval between two adjacent radio bursts, which is defined as the radio-burst time T_RB(s) in ETSI TS 103 357 V1.1.1 (2018-06).

Alternatively or in addition, it is provided according to the invention that radio bursts are combined into radio burst clusters, wherein the radio bursts within the radio burst clusters are each sent and/or received successively in the temporal transmission interval, and wherein at least one radio burst cluster on the uplink comprises less than 24 radio bursts and/or at least two radio burst clusters on the downlink comprise less than 18 radio bursts.

Alternatively or in addition, it is provided according to the invention that the temporal transmission interval (T_RB(s)) is greater than 655 symbols based on a symbol rate of 2,380,371 sym/s.

When a radio burst is received or sent, energy is drawn from the energy buffer, which causes the voltage of the energy storage device to drop briefly until the energy storage device is recharged from the battery. By means of the above measures, individually or in combination, the energy buffer can be effectively protected with regard to its discharge behavior, with the result that particularly inexpensive energy buffers can be used. This allows production costs to be effectively reduced without compromising the performance.

The respective pause can be provided in particular between two adjacent radio bursts of a frame, preferably the core frame and/or extension frame.

In particular, the radio burst clusters can also be formed by splitting blocks of individual radio bursts into at least two radio burst clusters, separated by the pause. A block pause can be maintained between the blocks.

The pause is preferably provided between two adjacent radio bursts of a frame, which each belong to different radio burst clusters.

The radio burst clusters separated by the respective pause can each comprise an identical number of radio bursts.

Preferably, in order to relieve the load on the energy buffer for generating the number of radio bursts in the respective radio burst cluster, the number of radio bursts per block predefined according to ETSI TS 103 357 V1.1.1 (2018-06) can be divided into whole numbers.

Preferably on the uplink, in a first part of the data packet or a frame of the data packet the pause can be omitted and in a second part of the data packet or a frame of the data packet the pause can be provided, or the pause can be provided in the first part of the data packet or frame of the data packet with a shorter length than in the second part of the data packet or frame of the data packet.

For example, the core frame can omit the pause, whereas the extension frame can contain the pause, or else the core frame and the extension frame can both contain the pause, wherein the pause of the core frame may be dimensioned shorter than the pause of the extension frame.

Advantageously, the position or distribution of the respective pause within the data packet or frame and/or the length of the respective pause and/or the number of radio bursts per radio burst cluster and/or the number of symbols per radio burst are predefined in such a way that the coherence time is maintained.

Accordingly, the radio bursts of at least one radio burst cluster can be within the coherence time, preferably the radio bursts of at least two radio burst clusters on the uplink can be within the coherence time and/or in a first part of the data packet transmission, fewer radio burst clusters can be within the coherence time than in a second part of the transmission.

Advantageously the accuracy of the quartz crystal of the node and/or of the quartz crystal of the base station can be included in the dimensioning of the length of the pause.

Furthermore, the radio bursts of at least one radio burst cluster can be within the coherence time, preferably the radio bursts of at least two radio burst clusters on the uplink can be within the coherence time and/or in a first or earlier part of the data packet transmission, fewer radio burst clusters can be within the coherence time than in a second or later part of the transmission.

Preferably, at least one frequency and/or time readjustment, preferably a plurality of successively occurring frequency and/or time readjustments, can be carried out on the reception of the radio bursts. In particular, this allows the following adaptation measures can be taken to relieve the load on the energy buffer:
before the first frequency and/or time readjustment, the number of symbols per radio burst (FB) is lower than after it, for example 24 symbols instead of 36 symbols, and/or
before the first frequency and/or time readjustment, the length of the respective pause (ΔT_add) is shorter than after it, and/or
before the first frequency and/or time readjustment, the average energy consumption per unit time is higher than after it,
before the first frequency and/or time readjustment, the average current drawn from the energy buffer is higher than after it,
before the first frequency and/or time readjustment, the length of the temporal transmission interval (T_RB(s)) is shorter than after it, and/or
before the first frequency and/or time readjustment, the number of radio bursts (FB) per radio burst cluster (CL1, CL+x) is lower than after it.

A frequency and/or time readjustment can therefore lead to a lengthening of the pause (ΔT_add) and/or the block pause (ΔT_dn) and/or of the temporal transmission interval (T_RB(s)). Accordingly, the length of the pause of the core frame can be dimensioned taking into account the accuracy of the quartz crystal of the node and/or the length of the pause of the extension frame can be dimensioned taking into account the accuracy of the quartz crystal of the base station. For example, in the uplink and/or downlink, the radio bursts or pauses of the core frame located therein can be initially divided up on the basis of the coherence time dependent on the quartz crystal used for the time measurement in the node. For the radio bursts or blocks of the extension frame containing radio bursts, a frequency and/or time readjustment, i.e. a re-synchronization, can be carried out and the pauses, or additional pauses, between the clusters of the extension frame can then be increased taking into account the coherence time. As a result, the core frame can be sent unchanged or at least with shorter pauses, whereas due to the increased coherence time in the extension frame, larger pauses can be provided in the extension frame.

It has been shown to be particularly advantageous for the energy buffer if radio burst clusters with nine radio bursts each are formed in the downlink and/or radio burst clusters with six radio bursts each are formed in the uplink.

Preferably, at least nine radio burst clusters are present in the downlink and at least twelve radio burst clusters in the uplink within the coherence time.

According to a further embodiment of the present invention, also claimed as a subclaim, it may be provided that in order to relieve the energy buffer or to avoid undershooting a minimum operating voltage, the length of the radio bursts is reduced by increasing the data rate compared to a data rate of 2,380,371 sym/s, and/or preferably for the downlink, the length of the radio bursts, preferably those of the extension frame, is limited to a value that is smaller than the maximum possible length of the radio bursts of the radio network, and/or the data packets are limited in size, and/or only radio bursts with a predefined maximum length are transmitted and/or allowed for further processing after receipt, and/or the transmission power is reduced to a value of less than 10dBm, and/or only a subset of radio bursts from the total number of radio bursts of the data packet is sent and/or allowed for further processing after receipt.

Limiting the length of each radio burst means that only radio bursts that match the predefined limit are sent. In particular, the length of the respective radio burst can be limited in such a way that a maximum “on-air time” is specified. Depending on the payload lengths, different radio burst lengths are obtained. The relationship is not linear, but follows a sawtooth function. Larger payload lengths can also lead to smaller radio burst lengths. Here, for example, additional dummy bytes are then added, so that a larger payload length is obtained, but which has smaller radio burst lengths.

Another way to use a small energy buffer is to limit the payload, i.e. to send essentially smaller data packets. For example, for very small energy buffers, instead of a 100-byte packet, 2 packets of 50 bytes each could be transmitted. This reduces the number of radio bursts per packet. The second packet is not transmitted until later, for example half an hour later.

If only radio bursts with a predefined maximum length are sent and/or allowed for further processing after reception, this ensures that the operating voltage will remain permanently above the threshold. This will compensate for a slightly lower fault resistance or a certain loss of sensitivity.

To relieve the load on the energy buffer, radio bursts of the core frame can be transmitted in shorter time intervals than those of the extension frame.

In addition, preferably on the uplink, the number of symbols per radio burst of the core frame is limited to a smaller number than the maximum possible number, in fact preferably to less than 36 symbols/radio burst.

According to the method according to the invention, an operating voltage threshold (e.g. 2.8-3.0 V) can be specified for the energy buffer, which serves as a control variable for the selection of the method mode for relieving the energy buffer according to the present invention. Preferably, the method mode can be selected from a number of multiple possible method modes.

In addition, the method mode can be calculated in advance. Depending on the operating voltage threshold, an approval determination can then be made at the base station as to the method mode under which the operation is to take place.

According to an exemplary embodiment of the invention, at least two different modes of sending and/or receiving radio bursts can be provided for selection, which have different effects on the discharging of the energy buffer. Preferably, the node signals which mode of the at least two modes is suitable or unsuitable for it based on its energy buffer. At the base station or in the headend an approval can then be determined, for example, as to whether a method mode according to the preceding claims is allowed or not.

Accordingly, a plurality of nodes with different energy buffers can be provided in the radio network.

An electrolytic capacitor is preferably used as the energy buffer. Such an energy buffer is 5-10 times cheaper than a hybrid layer capacitor (HLC).

The present invention further relates to a node according to the preamble of the independent node claim. which is characterized in that the microprocessor and/or the transceiver of the node is or are operated in accordance with the method according to the preceding claims.

Other features which are considered as characteristic for the invention are set forth in the appended claims.

Although the invention is illustrated and described herein as embodied in a method for operating a node in a radio network, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a highly simplified schematic illustration of a radio network, preferably an SRD radio network, for applying a method according to the present invention;

FIG. 2 is a block diagram of an example of functional elements comprised by a node of the radio network;

FIG. 3 is a schematic showing an example wiring configuration of the energy buffer of the node according to FIG. 2;

FIG. 4 are exemplary graphs of a current drawn and an operating voltage curve of an energy buffer of a node over time during emission of a data packet on the uplink and the downlink;

FIG. 5A is an exemplary illustration of a splitting of radio burst blocks into individual clusters and a separation of the clusters by the pause ΔT_add in an uplink;

FIG. 5B is an exemplary illustration of a formation of the clusters with intervening pauses ΔT_add in a downlink;

FIG. 6 are exemplary graphs of both the current drawn and the operating voltage curve of the energy buffer of the node over time during emission of a data packet on the uplink and on the downlink, thereby forming individual radio burst clusters and separating the clusters by the pause ΔT_add;

FIG. 7 is a graph showing a part of the operating voltage curve of the graph for the uplink in FIG. 6;

FIG. 8 shows a highly simplified schematic illustration of examples of different cluster arrangements according to the invention;

FIG. 9 is an illustration of an increase in a data rate as a measure to reduce the load on the energy buffer;

FIG. 10 is an illustration showing the “on-air time” of a radio burst depending on the payload or the length of the radio burst;

FIG. 11 is an illustration showing a division of a radio burst into two separate radio bursts as a measure to reduce the load on the energy buffer;

FIG. 12 is an illustration showing an example of radio bursts of specific length being allowed in the extension frame as a measure for reducing the load on the energy buffer; and

FIG. 13 is an illustration showing an example of the discharge of radio bursts as a measure to reduce the load on the energy buffer.

### DETAILED DESCRIPTION OF THE INVENTION

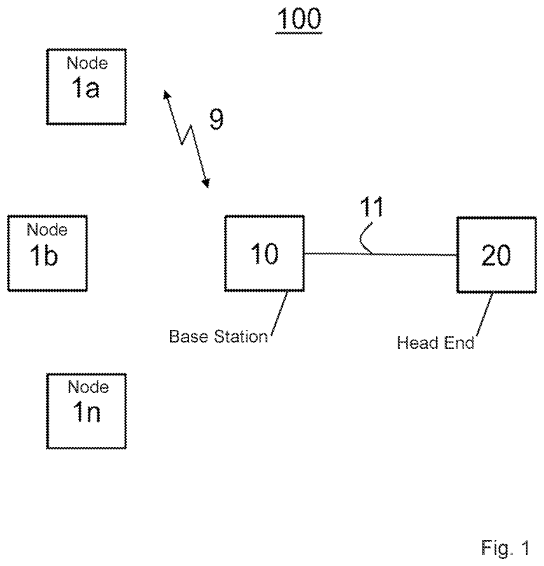

Referring now to the figures of the drawings in detail and first, particularly to FIG. 1 thereof, there is shown a radio network 100, preferably of the type defined in the ETSI TS 103 357 V1.1.1 (2018-06) standard. It contains a plurality of individual energy-independently operated nodes 1a-1n and a base station 10 (sometimes also called a data collector). Nodes 1a-1n are in particular sensor devices, actuators or combinations thereof for use in the so-called IoT. In these, data from the individual nodes 1a-1n is transmitted by means of radio transmission 9 to the base station 10 (uplink) and/or data is transmitted from the base station 10 by means of the radio transmission 9 to the individual nodes 1a-1n (downlink). The individual nodes 1a-1n are located in transmission and reception range of the respective base station 10.

The nodes 1 can be, for example, water, gas, electricity or energy meters.

The data of the nodes 1a-1n received from the base station 10 can then be transmitted via a suitable data transmission means 11 to a headend 20 or to a data center. The data transmission means 11 can be, for example, a cellular connection or an internet connection or a combination of these. The data is transmitted by telegram splitting in the narrow band, preferably in the ultra-narrow band, especially preferably within the context of so-called telegram splitting (TS-UMB family). The uplink usually primarily relates to the transmission of user data generated in the individual nodes 1a-1n and/or operational data of the individual nodes. The data provided by the headend 20 for the base station 10 via the data transmission means 11 and transmitted onward in the downlink by radio transmission 9 to nodes 1a-1n is primarily configuration data, data for the operating system of the individual nodes, software updates, etc.

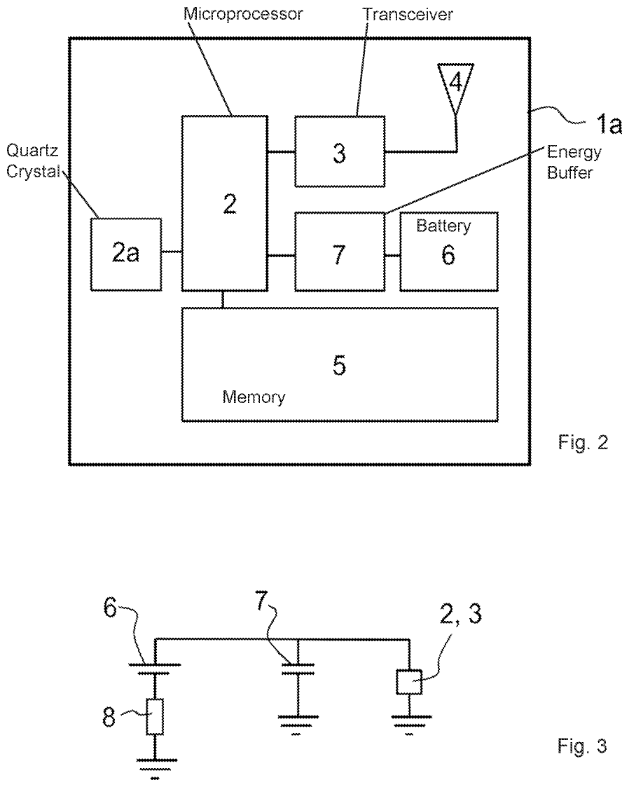

FIG. 2 shows the exemplary structure of the node 1a for use in the method according to the invention. The node 1a comprises a microprocessor 2, a transceiver 3 and an antenna 4 for transmitting or receiving radio signals of the radio transmission 9. Furthermore, the node 1a contains a memory 5, a battery 6 and an energy buffer 7. The battery 6 is preferably a so-called long-life battery, that is, a non-rechargeable battery, which over the entire use cycle of the node 1a supplies the latter with energy until the battery needs to be replaced. Such long-life batteries have a lifetime of more than 10 years, assuming a normal power consumption of the node 1a. The power to the microprocessor 2 or transceiver 3 or memory 5 is supplied via the energy buffer 7 upstream of the battery 6, which is discharged when an energy demand occurs and then recharged by the battery. The aforementioned components of the node 1a, such as the microprocessor 2, the transceiver 3, the antenna 4 and/or the memory 5 can also be provided in module components.

Reference sign 2a refers to a quartz crystal which is provided both as a time measuring device, i.e. acts as a time reference, and for generating the carrier signal. The base station is also equipped with a quartz crystal (not shown in the figures), which generates the clock for the carrier signal for the carrier frequency of the radio signal sent by the base station 10 and is responsible for the time measurement carried out there. The two crystals differ in their accuracy. The crystal of the base station 10 has an accuracy of approximately 2 ppm, whereas the crystal 2a has an accuracy of only approximately 20 ppm.

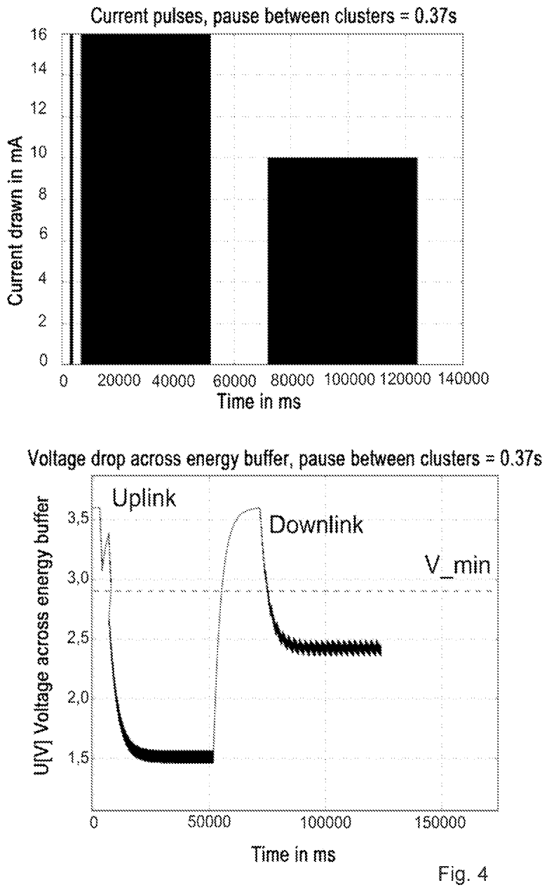

As can be seen from FIG. 3, the battery 6 has a specific internal resistance 8. The microprocessor 2 and transceiver 3 form the “consumers” of the energy stored in the energy buffer 7. If the energy stored in the energy buffer 7 is consumed by the microprocessor 2 or transceiver 3, for example, because a data packet (telegram) is sent or received, the energy buffer 7 is discharged for a certain length of time until it is recharged by the battery 6. This causes a voltage drop in the energy buffer 7. The voltage drop depends on the energy required by the consumer. The voltage drop and recharging of the energy buffer 7 are shown below using an example:

$${U}_{t 2} = {U}_{t 1} - \frac{{It}_{on}}{c} . \qquad ( 1 )$$

An initial voltage U_t1=3.6V, a current pulse of a current of t_on=10 ms, I=20 mA and a capacitor of C=860 μF result in a new voltage of U_t2=3.367 V. After the “consumer” has finished drawing the current, the energy buffer 7 is slowly charged from the battery 6:

$${U}_{t 3} = {U}_{battery} - ( {U}_{battery} - {U}_{t 2} ) {e}^{- \frac{{t}_{off}}{RC}} . \qquad ( 2 )$$

An initial voltage U_t1=3.367V, a recovery period of t_off=150 ms, an internal resistance of the battery of R=1000Ω and a capacitor of C=860 μF result in a new voltage of U_t3=3.404 V.

The electronics of the node 1a requires a stable voltage of the energy buffer 7 in order for it to function. A stable voltage means a minimum voltage or a voltage threshold that must not be undershot during operation. For example, the minimum voltage for a conventional node is in the range from 2.7 to 3.0 V.

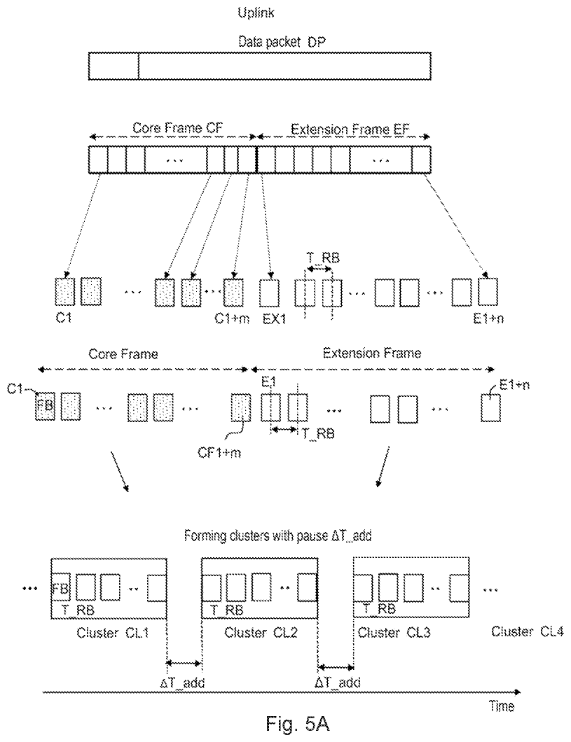

For better understanding, the illustration above left in FIG. 4 shows an example of a current profile for the transmission of a telegram in the uplink in the conventional telegram splitting method, and on the right a current profile in the downlink for the reception of all sub-data packets by the node, also in the conventional telegram splitting method. Telegram splitting method means that a data packet is split into individual sub-data packets and the sub-data packets are each sent successively as a radio burst, received by the receiver and recombined again to form the information in the data packet. The time interval T_RB for the continuous successive transmission of the sub-data packets is on average approximately 150 ms in the uplink and approximately 220 ms in the downlink.

According to the invention, the sub-data packets can be sent via a single frequency channel or alternatively via multiple different frequency channels in the so-called frequency hopping procedure.

As can be seen from FIG. 4, in the conventional method the energy buffer 7 is strongly discharged by sending a data packet on the uplink until it is charged above the operating voltage threshold V_min again at approx. 2.9 V over the period of a pause of 0.37 s due to the charging by the battery 6. When a data packet is received by the receiver of the node on the downlink, the energy buffer 7 is again strongly discharged. Subsequently it is recharged, which is not shown in the upper illustration of FIG. 4. It can be seen that the energy buffer 7 is below the operating voltage threshold V_min line for a considerable period of time during the uplink and downlink. Up to now, so-called hybrid layer capacitors (HLCs) are commonly used to prevent excessive discharge. HLCs are expensive.

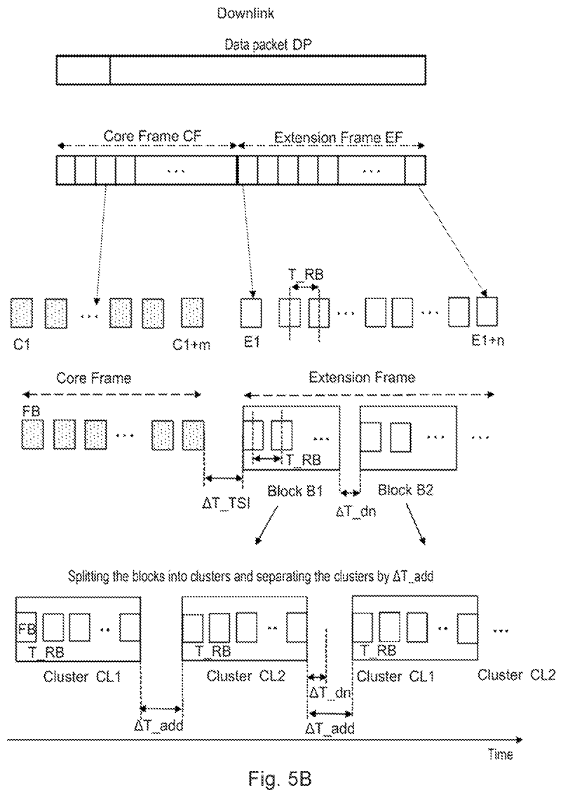

FIGS. 5A and 5B show sections of the so-called telegram splitting procedure, in which according to ETSI TS103 357 V1.1.1 (2018-06) a data packet DP, which is intended for sending in the uplink or for receiving in the downlink by the respective node 1a to 1n, is divided, i.e. “split”, into individual sub-data packets C1 to C1+m, E1 to E1+n. For the transmission of the data packet DP, this can first be split into a so-called core frame CF and an extension frame EF, wherein the extension frame EF usually at least essentially contains user data, and the core frame CF at least essentially contains control information. For transmission, the data of the extension frame EF is split into individual sub-data packets E1 to E1+n. Likewise, on the uplink, the data of the core frame CF is also split into sub-data packets C1 to C1+m, as shown in FIGS. 5A and 5B respectively.

As shown in FIG. 5B, according to ETSI TS103 357 V1.1.1 (2018-06), the individual sub-data packets E1 to E1+n and the corresponding radio bursts FB are transmitted after being combined in a plurality of blocks B1, B2, . . . . Adjacent radio bursts generally have a time interval T_RB, as shown in the examples of FIG. 5A and 5B respectively for two radio bursts FB of the extension frame. The pause between the core frame and extension frame is defined as ΔT_si in ETSI TS 103 357 V1.1.1 (2018-06). A block B in the downlink in conventional radio systems consists of, for example, 18 radio bursts or sub-data packets E1-E18. A block pause ΔT_dn is conventionally provided between the respective blocks. In the ETSI TS103 357 V1.1.1 (2018-06) radio standard, this block pause may be a maximum of 7,168 symbols, based on a symbol rate of 2,380,371 sym/s. This corresponds to a time value of 3.011 seconds.

A block B in the uplink conventionally consists of, for example, 24 radio bursts or sub-data packets E1-E24.

In order not to fall below the operating voltage threshold V_min of the energy buffer 7, according to one aspect of the present invention, on the one hand, a pause (ΔT_add) is provided between two adjacent radio bursts (FB) of a frame on the uplink and/or downlink, which is longer than 7,168 symbols based on a symbol rate of 2 380.371 sym/s.

On the other hand, it is alternatively or additionally provided to set the temporal transmission interval (T_RB(s)) on the uplink and/or downlink so that it is greater than 655 symbols based on a symbol rate of 2,380,371 sym/s.

It is alternatively or additionally provided to divide the radio bursts FB of the core frame CF and extension frame EF into clusters CL1 and CL2 on the uplink and to provide a pause ΔT_add between each of the clusters, as shown in FIG. 5A by way of example. Further, according to FIG. 5B, corresponding clusters CL with a pause ΔT_add can also be formed on the downlink. On the downlink, blocks B1, B2, . . . of the extension frame can be split and separated by the pause ΔT_add. The clusters CL of different blocks can also be separated from one another with the pause ΔT_add. The pause ΔT_add is then greater than the block pause ΔT_dn. This is shown in FIG. 5B. Alternatively, however, the block pause ΔT_dn could also be retained. Preferably, in order to relieve the energy buffer for generating the number of radio bursts in the respective radio burst cluster, the number of radio bursts per block predefined according to ETSI TS 103 357 V1.1.1 (2018-06) can be divided into whole numbers. For example, for the uplink according to FIG. 5A, the 24 radio bursts FB of a block B can be divided e.g. into four clusters CL1-CL4 with six radio bursts each and sent offset with respect to each other by means of the additional pause ΔT_add.

Likewise, on the downlink according to FIG. 5B, a block can be split into two clusters with 9 radio bursts each and received from the node spaced apart from each other by means of the additional pause ΔT_add.

In FIG. 5B, the core frame is transmitted without a pause and only the blocks of the extension frame are split into clusters. Alternatively, however, the core frame can also be split into clusters by means of additional pauses ΔT_add, i.e. clusters can be sent or received with intervening pauses ΔT_add in order to relieve the energy buffer.

The length of the pause ΔT_add can remain constant or variable in the uplink and/or downlink. Accordingly, the length of the pause ΔT_add in the core frame can be shorter than in the extension frame.

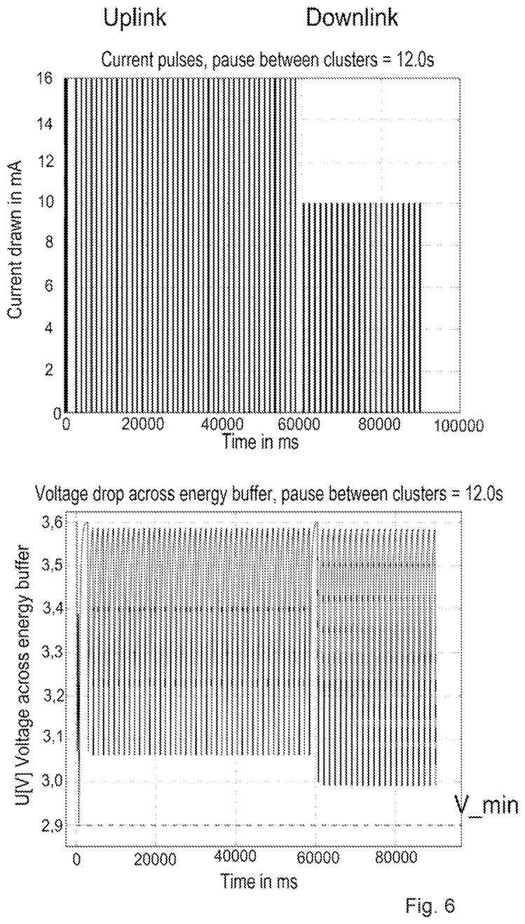

The upper illustration of FIG. 6 shows, by way of example, the current drawn from the energy buffer 7 both on the uplink and on the following downlink. Each dash in this illustration corresponds to a cluster CL containing a plurality of radio bursts. The time between two dashes corresponds to the respective pause ΔT_add. In the example of FIG. 6, the pause is ΔT_add 12 s.

The lower illustration in FIG. 6 shows the change in the operating voltage of the energy buffer 7 during the respective discharges caused by the transmission or reception at node 1. It can be seen that the clustering and the respective pause ΔT_add do not cause the operating voltage of the energy buffer 7 to fall below the operating voltage threshold V_min for both the uplink and the downlink, so that the operating voltage of the energy buffer remains at the required level.

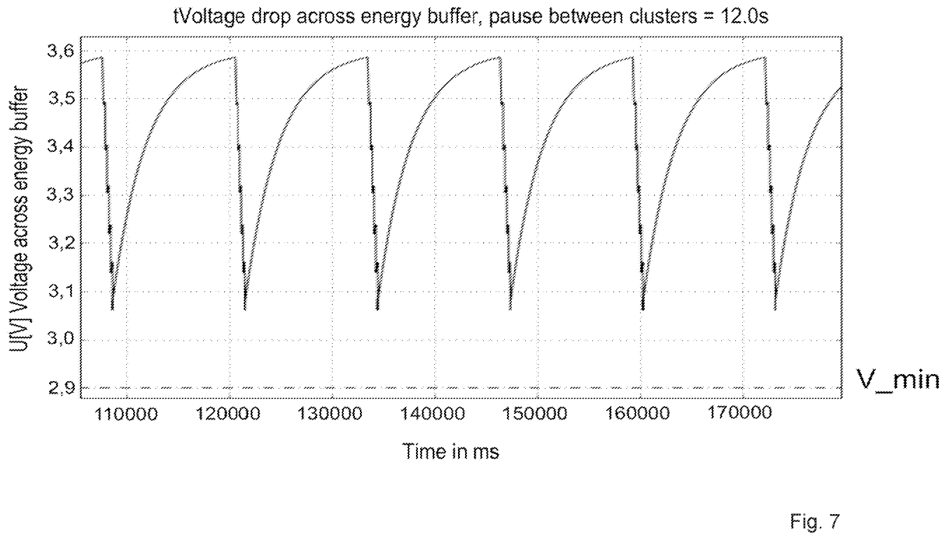

FIG. 7 shows, for example, a zoomed out version of the discharge curves of FIG. 6 on the downlink with six clusters each, each containing nine radio bursts.

With regard to the dimensioning of the additional pause ΔT_add, i.e. the time interval between the respective clusters CL, the so-called coherence time must be observed. The coherence time is the time in which a radio burst FB of a transmission can still be used by the receiver without needing to readjust the frequency or time. The coherence time is defined by specifying a maximum time error in the form of a fraction of the symbol duration (e.g. 0.25). The coherence time depends on the frequency accuracy of the frequency quartz crystal and can be represented as follows:

$${t}_{{block \_ dowlink}_{max}} = \frac{105.0256 μs}{5 ppm} = 21. s$$

The 5 ppm corresponds to the frequency accuracy of the carrier frequency of the downlink signal coming from the base station due to the usually higher quality quartz crystal used there. The 20 ppm corresponds to the frequency accuracy of the uplink signal sent by the node. The value 105.0256 μis a ¼ fraction of the symbol duration. The sampling points in the receiver, caused by the transmitter and receiver, therefore deviate less than the symbol duration divided by 4. This allows the symbol to be reconstructed well in the receiver. There are no signal-to-noise ratio (SNR) losses due to the deviating sampling point.

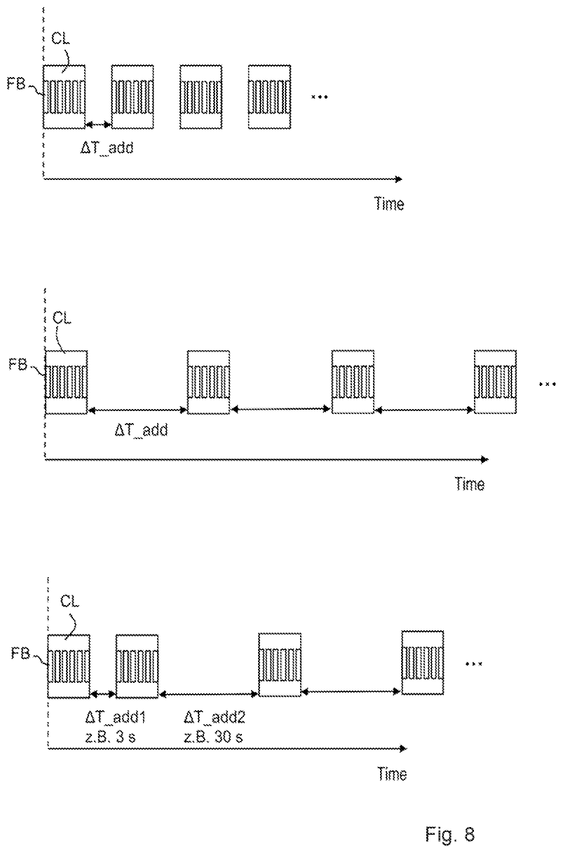

One possibility according to the invention is to choose the additional pause ΔT_add according to FIG. 8 above in such a way that the coherence time is maintained. It is then not necessary to readjust the frequency or time in the receiver.

Alternatively, the pause ΔT_add according to FIG. 8 center can also be chosen in such a way that it is outside the coherence time. Frequency and/or time must then be readjusted.

Alternatively, there is also the option of a mixture, as shown in FIG. 8, bottom. This means that a pause ΔT_add between two clusters CL is within the coherence time and a second pause between two clusters CL is outside the coherence time. This option is particularly interesting for the uplink.

In the uplink, due to the greater inaccuracy of the quartz 2a used there the coherence time is:

$${t}_{{block \_ dowlink}_{max}} = \frac{105.056 μs}{20 ppm} = 5.25 s .$$

After the core frame CF has been received on the uplink, in the receiver, i.e. by the base station 10, the radio bursts or radio burst clusters following the core frame CF can be subjected to at least one, preferably a plurality, of frequency and/or time readjustment(s). This results in the advantage that for the subsequent radio bursts FB or radio burst clusters, the time accuracy requirement can be reduced. As a result, a longer coherence time can therefore be estimated for the radio bursts FB of the extension frame EF on the uplink as follows:

$${t}_{{block \_ dowlink}_{max}} = \frac{105.056 μs}{20 ppm} = 5.25 .$$

The coherence time can therefore be extended from 5.15 s to a maximum of 52.53 s. The result of this is that the radio bursts or radio burst clusters CL1, CL+x of the extension frame EF can be separated by using a larger pause (ΔT_add2>ΔT_add1) without the need for re-synchronization. This is represented schematically in FIG. 8 (bottom).

For the downlink, this allows an improvement (increase in the coherence time) by a factor of 2.5 to be achieved, for the uplink even by a factor of 10. On the uplink, after 12 radio bursts have been received the carrier frequency is known. This allows the accuracy to be reduced to 20 ppm, as described above. This again allows the number of radio bursts (FB) per radio burst cluster to be reduced. For example, instead of the 24 radio bursts, only 12 radio bursts may be sufficient in the uplink. Preferably, in the downlink a radio burst cluster (CL1, CL+x) comprises nine radio bursts and in the uplink twelve radio bursts.

Furthermore, after the initial frequency and/or time adjustment, the number of symbols per radio burst (FB) can be reduced, for example to 24 instead of 36 symbols per burst.

With a coherence time of 52.53 s, in the uplink a pause ΔT add of e.g. 12 s can be provided between the individual, e.g., four clusters CL1-CL4, each containing six radio bursts, so that the total time for the uplink adds up to 36 s, which lies within the coherence time of 52.53 s.

Due to the initial frequency and/or time readjustment, the length of the temporal transmission interval (T_RB(s)) can also be extended compared to the previous value.

Accordingly, by carrying out at least one frequency and/or time readjustment, the average energy consumption per unit time and the average current drawn from the energy buffer for the radio bursts following the frequency and/or time readjustment can be reduced, thereby effectively protecting the energy buffer.

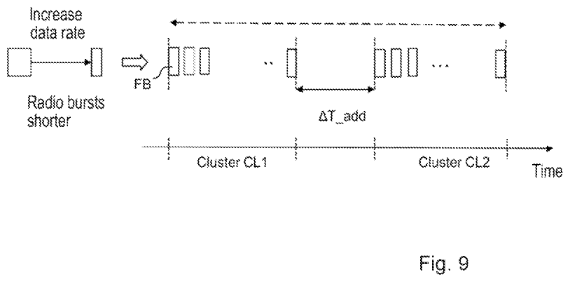

In order to avoid excessive discharging of the energy buffer 7, the data rate can also be increased. For example, the data rate can be increased compared to a data rate of 2,380,371 sym/s. This causes the data packets or telegrams to become shorter and less energy is required from energy buffer 7. For example, increasing the data rate by a factor of 2 makes the radio bursts FB of the data packet shorter by a factor of 2. This on its own can help to relieve the energy buffer. In addition, the increase in the data rate can also be used in combination with the provision of the pause ΔT_add. The two measures can therefore be advantageously combined. While increasing the data rate means that the sensitivity will deteriorate somewhat, it nevertheless allows the use of cheaper components in the node. For example, the headend 20 can thus assign different data rates to the individual nodes. The increase of the data rate in combination with the use of a pause ΔT_add is shown schematically in FIG. 9.

The radio bursts FB on the downlink have different lengths depending on the payload. Another way of relieving the energy buffer 7 is to allow radio bursts FB with a specific length, so that only radio bursts FB that do not exceed this size are sent and received by the node.

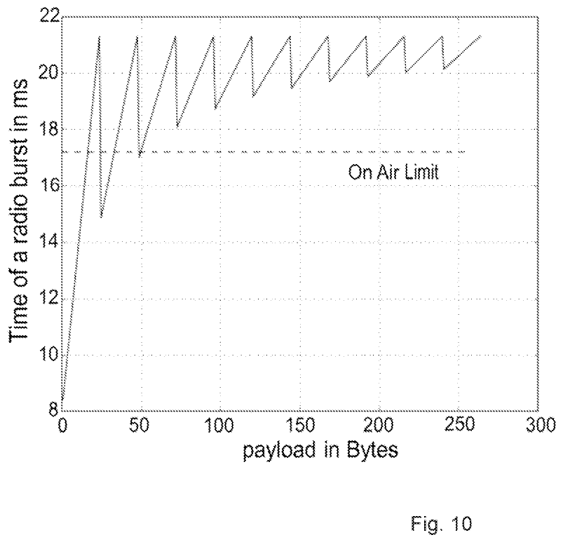

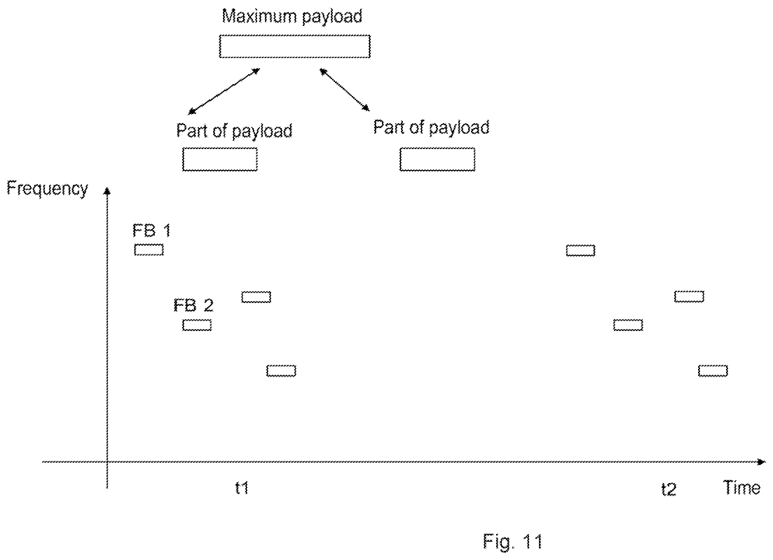

The graph of FIG. 10 shows the relationship between the payload, i.e. the length of the radio burst FB, as a function of the “on-air time” of the radio burst. As the length of the radio bursts FB increases, the “on-air time” of the same also increases. For a larger continuous payload, i.e. in one radio burst, more energy is consumed, so that the requirement on the operating voltage of the energy buffer 7 can no longer be met. A measure taken by the present invention is therefore to split the payload into parts and to send and/or receive the parts of the payload in split form by means of multiple radio bursts in order to satisfy the voltage requirement. A corresponding sub-division of the payload is shown schematically in FIG. 11. Each radio burst FB1, FB2 contains one part of the maximum payload PL. This measure can be used in isolation to relieve the energy buffer 7 or else in conjunction with the above-mentioned measures (pause ΔT_add and/or increasing the data rate).

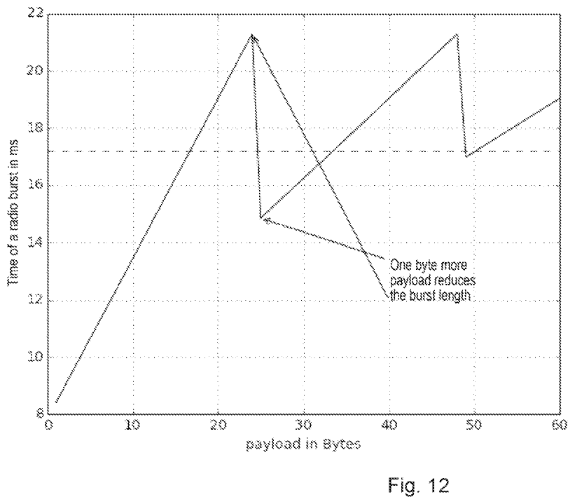

Instead of splitting the payload or the data packet, any radio bursts that exceed a certain length (L_max) cannot be allowed for reception, for example, and so cannot be processed. The relationship between payload and the length of the radio burst of the sawtooth curve of FIG. 10 is illustrated for the range between 20 and 30 bytes in FIG. 12.

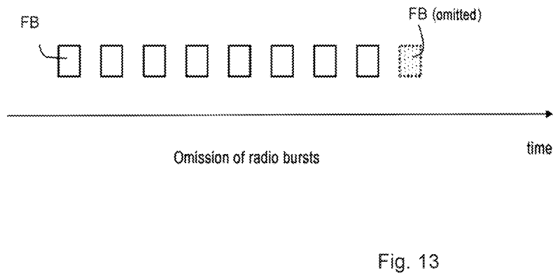

Another measure to be applied in isolation or in connection with the other solution ideas to relieve the energy buffer 7 consists of omitting radio bursts of the transmission and/or reception chain of the radio bursts of the data packet. Instead of sending or receiving, for example, nine radio bursts, this can also be, as apparent from FIG. 13, only eight radio bursts. This also allows the operating voltage of the energy buffer 7 to be kept above the operating voltage minimum V_min. In return, it is necessary to accept a slightly lower fault resistance and possibly a slight loss of sensitivity. This measure can be used in isolation to relieve the energy buffer 7 or else in conjunction with the above-mentioned measures (pause ΔT add and/or increasing the data rate and/or splitting the radio bursts).

Another measure to relieve the energy buffer 7 is, preferably in the uplink, to limit the number of symbols per radio burst FB of the core frame CF to a smaller number than the maximum possible number. According to ETSI TS 103 357 V1.1.1 (2018-06), a radio burst of the core frame CF on the uplink consists of 36 symbols (bits). For example, it is possible to send only 26 symbols (bits) per radio burst FB in the core frame CF. This also relieves the load on the energy buffer 7 by not allowing the discharge of the same to fall below the operating voltage threshold V_min. This measure may be used either alone or in combination with one or all of the above-mentioned measures.

As a further measure to protect the energy buffer, the transmission power can be reduced to a value of less than 10 dBm. This measure may also be used either alone or in combination with one or all of the above-mentioned measures.

According to the invention, a concrete value for the operating voltage threshold V_min for the energy buffer 7 can be predefined, which can be provided simultaneously as a control parameter or control variable for selecting a method mode, preferably from a plurality of selectable method modes. Such a method mode may be one of the above measures of providing a pause ΔT_add, increasing the data rate, allowing certain lengths of radio bursts, omission of radio bursts, radio bursts with a lower symbol count, or a combination thereof. The fact that, depending on the specific product, different transmission and/or reception currents can be used, batteries can have different internal resistances, sensors can have different voltage requirements, a predetermined operating mode that can be selected as required can provide considerable benefits in use.

Similarly, according to the invention, the voltage can be monitored as a control variable and if a certain voltage is present, a certain method mode can be selected in which the energy buffer 7 is protected by the measures described.

Another aspect of the invention involves providing at least two different modes of sending and/or receiving the radio bursts or radio burst clusters, which have different effects on the discharging of the energy buffer 7. In this case, node 1 can signal to the base station 10 which mode is suitable based on its energy buffer 7. Communication in the radio network can then be carried out by selecting the appropriate mode. Similarly, calculations can be performed in advance to determine which method mode is appropriate for which node. Depending on the result, only method modes which reliably exclude a discharge of the energy buffer 7 below the voltage threshold value V_min can be allowed. This is advantageous if nodes are operated with different energy buffers in the radio network (radio cells).

With the present invention, a considerable cost saving in the manufacture of nodes for an SRD radio network can thus be achieved by the possibility of using less expensive energy buffers. It is explicitly pointed out that even sub-combinations of features in the description, even if not explicitly mentioned, are considered essential to the invention.

The following is a summary list of reference numerals and the corresponding structure used in the above description of the invention.

### LIST OF REFERENCE SIGNS

1a-1n nodes
2 microprocessor
2a quartz crystal (time)
2b quartz crystal (carrier frequency)
3 transceiver
4 antenna
5 memory
6 battery
7 energy buffer
8 internal resistance
9 radio transmission
10 base station
11 data transmission means
20 headend
100 near-range radio network
FB radio burst
CF core frame
EX extension frame
C sub-data packet
E sub-data packet
DP data packet
B block
CL cluster
PL payload

1. A method for operating a node in a radio network having at least one said node and at least one base station, the node having a transmitter and/or a receiver for transmitting radio telegrams in a form of data packets on an uplink and/or for receiving the data packets on a downlink, a battery and an energy buffer, which comprises the steps of:
splitting each of the data packets on the uplink and/or the downlink into a plurality of individual sub-data packets, and each of the individual sub-data packets being sent and/or received successively in a temporal transmission interval in a form of a radio burst;
providing at least two pauses, wherein a respective pause of the pauses is provided between two adjacent radio bursts and is in each case longer than 7,168 symbols based on a symbol rate of 2,380,371 sym/s; and/or
combining radio bursts into radio burst clusters, wherein the radio bursts within the radio burst clusters are each sent and/or received successively in the temporal transmission interval, and wherein at least one radio burst cluster on the uplink contains less than 24 said radio bursts and/or at least two of the radio burst clusters on the downlink contain less than 18 said radio bursts; and/or
setting the temporal transmission interval to be greater than 655 symbols based on a symbol rate of 2,380,371 sym/s.

2. The method according to claim 1, wherein the respective pause is provided between the two adjacent radio bursts of a frame.

3. The method according to claim 1, wherein the respective pause is provided between the two adjacent radio bursts of a frame, which each belong to different radio burst clusters.

4. The method according to claim 1, wherein the radio burst clusters each contain an identical number of the radio bursts.

5. The method according to claim 1, wherein in order to generate a number of said radio bursts in a respective radio burst cluster, the number of said radio bursts per block predefined in ETSI TS 103 357 V1.1.1 (2018-06) is divided into whole numbers.

6. The method according to claim 1, wherein on the uplink, in a first part of a data packet or a frame of the data packet the pause is not provided and in a second part of the data packet or the frame of the data packet the pause is provided, or the pause in the first part of the data packet or the frame of the data packet is provided with a shorter length than in the second part of the data packet or the frame of the data packet.

7. The method according to claim 6, wherein the individual sub-data packets are part of a core frame and/or an extension frame, the core frame contains no said pause and the extension frame contains the pause, or the core frame and the extension frame each contain the pause, the pause of the core frame being smaller than the pause of the extension frame.

8. The method according to claim 2, wherein a position or distribution of the pause within the data packet or the frame and/or a length of the pause and/or a number of the radio bursts per radio burst cluster and/or a number of the symbols per the radio burst are specified such that a coherence time is maintained.

9. The method according to claim 8, wherein the radio bursts of at least one said radio burst cluster are within the coherence time, and/or in a first part of the data packet transmission, fewer said radio burst clusters are within the coherence time than in a second part of the transmission.

10. The method according to claim 1, wherein an accuracy of a quartz crystal of the node and/or of a quartz crystal of the base station is included in a dimensioning of a length of the pause.

11. The method according to claim 1, wherein the radio bursts of at least one radio burst cluster are within a coherence time, and/or in a first part of the data packet transmission, fewer said radio burst clusters are within the coherence time than in a second part of the transmission.

12. The method according to claim 1, which further comprises carrying out a frequency and/or time readjustment, wherein:
a number of the symbols per said radio burst is lower than after it; and/or
before a first said frequency and/or the time readjustment, a length of the pause is shorter than after it; and/or
before the first frequency and/or the time readjustment, an average energy consumption per unit time is higher than after it; and/or
before the first frequency and/or the time readjustment, an average current drawn from the energy buffer is higher than after it; and/or
before the first frequency and/or the time readjustment, a length of the temporal transmission interval is shorter than after it; and/or
before the first frequency and/or time readjustment, the number of the radio bursts per the radio burst cluster is lower than after it.

13. The method according to claim 1, wherein the individual sub-data packets are part of a core frame and/or an extension frame and the pause between the radio burst clusters of the extension frame is greater than the pause between the radio burst clusters of the core frame.

14. The method according to claim 1, wherein:
the radio burst clusters with nine radio bursts each are formed on the downlink; and/or
the radio burst clusters with six radio bursts each are formed on the uplink.

15. The method according to claim 1, wherein at least nine said radio burst clusters in the downlink and at least twelve said radio burst clusters in the uplink are within a coherence time.

16. A method for operating a node in a radio network having at least one said node and at least one base station, wherein the node contains a transmitter and/or receiver for transmitting radio telegrams in a form of data packets on an uplink and/or for receiving the data packets on a downlink, a battery and an energy buffer, which comprises the steps of:
splitting each of the data packets on the uplink and/or the downlink into into a plurality of individual sub-data packets, and each of the sub-data packet is sent and/or received successively in a temporal transmission interval in a form of a radio burst;
reducing a load on the energy buffer by:
reducing a length of radio bursts by increasing a data rate compared to a data rate of 2,380,371 sym/s; and/or
limiting the length of the radio bursts to a value that is smaller than a maximum length of the radio bursts of the radio network; and/or
limiting a length of a payload to a value that is smaller than a maximum length of the payload; and/or
reducing transmission power to a value of less than 10 dBm; and/or transmitting and allowing only the radio bursts with a predefined maximum length for further processing after receipt; and/or
sending and allowing only a subset of the radio bursts from a total number of the radio bursts of the data packet for further processing after receipt.

17. The method according to claim 16, which further comprises:
limiting the length of a respective one of the radio bursts such that a maximum on-air time is specified by adding additional dummy bytes; or
limiting the maximum length of the payload such that only part of the data packet is initially transmitted.

18. The method according to claim 16, wherein the individual sub-data packets are part of a core frame and/or an extension frame, wherein the radio bursts of the core frame are transmitted in shorter time intervals than those of the extension frame.

19. The method according to claim 18, wherein on the uplink a number of symbols per the radio burst of the core frame is limited to a smaller number than a maximum number of the symbols.

20. The method according to claim 16, wherein an operating voltage threshold is specified, which is used as a control variable.

21. The method according to claim 16, wherein a plurality of nodes having different energy buffers is provided in the radio network.

22. The method according to claim 16, wherein at least two different modes of sending and/or receiving said radio bursts are predefined for selection, which have different effects on discharging of the energy buffer.

23. The method according to claim 16, which further comprises using an electrolytic energy buffer or an energy buffer with a capacitance of up to 25,000 μF as the energy buffer.

24. A node for a radio network for communication with a base station of the radio network on an uplink and/or a downlink, the node comprising:
a microprocessor;
a transmitter and/or a receiver for transmitting radio telegrams in a form of data packets on the uplink and/or for receiving the data packets on the downlink;
a battery;
an energy buffer; and
said microprocessor and/or said transmitter and/or said receiver, are operated according to the method of claim 1.
